(19) United States
(12) Patent Application Publication
(10) Pub. No.: US 2023/0176545 A1
(43) Pub. Date: Jun. 8, 2023

(54) Use of generalised homogeneity to improve a PID control

(71) Applicant: INSTITUT NATIONAL DE RECHERCHE EN INFORMATIQUE ET EN AUTOMATIQUE, Le Chesnay (FR)

(72) Inventors: Siyuan Wang, Le Chesnay Cedex (FR); Andrey Polyakov, Le Chesnay Cedex (FR); Gang Zheng, Le Chesnay Cedex (FR)

(21) Appl. No.: 17/925,148

(22) PCT Filed: May 11, 2021
(86) PCT No.: PCT/FR2021/050828

§ 371 Date: Nov. 14, 2022

(30) Foreign Application Priority Data
May 12, 2020 (FR) FR2004684

(51) Int. Cl. G05B 19/4155

(52) U.S. Cl. CPC G05B 19/4155; G05B 2219/42033

(57) ABSTRACT

A device for digitally controlling a system, operating by discrete time steps, based on an error vector received at each time step, which includes: an estimator determining a homogenous canonical norm value range for a current time step, an error vector of a current time step, an expansion generator matrix, a Lyapunov matrix, lower and upper limits; and a computer that returns a control for the current time step based on the sum between the error vector of the current time step multiplied by a factor of a feedback gain matrix, the homogenous canonical norm value range for a current time step, proportional and derivative coefficients and the expansion generator matrix, and the integral between the first time step and the current time step of a product associating an integral coefficient, the expansion generator matrix, the homogenous canonical norm value range for all the time steps and the error vector.

### CROSS-REFERENCE TO RELATED APPLICATIONS

This Application is a Section 371 National Stage Application of International Application No. PCT/FR2021/050828, filed May 11, 2021, which is incorporated by reference in its entirety and published as WO 2021/229186 A1 on Nov. 18, 2021, not in English.

### FIELD OF THE DISCLOSURE

The invention relates to the field of controllers for the control of systems, and more particularly of controllers of the PID (proportional-integral-derivative) type. The control of a value involves the measurement, in real time, of the difference, called error, between the real value of this value and the set point to be reached. A controller then applies to this error a transfer function. The result of this transfer function forms a control to be applied to reduce the error between set point and real value of the value to be controlled.

### BACKGROUND OF THE DISCLOSURE

PID controllers are characterised by an operating law comprising a proportional term, a derivative term and an integral term, hence the name. PID controllers are linear, that is to say that their transfer function is a linear function. The tuning of a linear PID controller requires the adjustment of three coefficients to tune this PID controller, which makes linear PID controllers simple to implement. The control carried out with a well-tuned linear PID controller is robust (i.e. resistant to disturbances), fast (i.e. with a low response time) and precise (i.e. the asymptotic error is substantially null). These qualities, associated with the simplicity of the tuning of PID controllers, make them the most used controllers in the industry.

Thus, for example, almost all quadcopter drones are controlled by linear PID controllers. A PID controller is very effective for controlling a drone in the context of a model with low pitch and roll disturbances around the horizontal position of the drone. The non-linear effects of this type of model are relatively weak, and can be processed as uncertainties and minimised by the tuning of the controller, for example by using an H-infinity criterion.

Linear PID controllers are not perfect, however, and there is a need for better performing controllers.

Non-linear controllers of the sliding mode control, or SMC, type are known, as described in the article by Xu, R., & Ozguner, U. (2006, December) “Sliding mode control of a quadrotor helicopter”, In Proceedings of the 45th IEEE Conference on Decision and Control (pp. 4957-4962). IEEE.

The article by Lee, D., Kim, H. J., & Sastry, S. (2009), “Feedback linearization vs. adaptive sliding mode control for a quadrotor helicopter”, International Journal of control, Automation and systems, 7(3), 419-428, compares the performance between a controller of the SMC type and a controller of the type with feedback linearisation, or FLM (feedback linearization method).

The article by Besselmann, T., Lofberg, J., & Morari, M. (2012), “Explicit MPC for LPV systems: Stability and optimality.” IEEE Transactions on Automatic Control, 57(9), 2322-2332″, describes a non-linear controller of the type with model predictive control, or MPC.

The articles Milhim, A., Zhang, Y., & Rabbath, C. A. (2010). “Gain scheduling based PID controller for fault tolerant control of quad-rotor UAV. In AIAA infotech@ aerospace 2010 (p. 3530)” and Ataka, A., Tnunay, H., Inovan, R., Abdurrohman, M., Preastianto, H., Cahyadi, A. I., & Yamamoto, Y. (2013, November), “Controllability and observability analysis of the gain scheduling based linearization for uav quadrotor” In 2013 International conference on robotics, biomimetics, intelligent computational systems (pp. 212-218). IEEE describe non-linear controllers of the PID type with a switch using gain scheduling.

None of these non-linear controllers are satisfactory. The controllers of the SMC type and the controllers of the type with a switch have a chattering problem, as described in the article by Xu, R., & Ozguner, U. (2006, December), “Sliding mode control of a quadrotor helicopter” In Proceedings of the 45th IEEE Conference on Decision and Control (pp. 4957-4962). IEEE. The algorithmic complexity of the controllers of the MPC and FLM type is too great for them to be implemented in practice.

### SUMMARY

The invention improves the situation. For this purpose, it proposes a digital control device for the control of a system to be controlled digitally, operating by discrete time steps, on the basis of an error vector received at the input at each time step, comprising a memory arranged to receive data of control parameters comprising a homogeneity factor chosen in the range [-1; 0], a feedback gain matrix linked to the system to be controlled, an expansion generator matrix, a Lyapunov matrix defining a homogenous canonical norm, a lower limit, an upper limit, and a proportional coefficient, a derivative coefficient and an integral coefficient characteristic of the system to be controlled, an estimator arranged to determine a homogenous canonical norm value range for a current time step on the basis of the estimation ranges of the preceding time steps, the error vector of the current time step, the expansion generator matrix, the Lyapunov matrix, the lower limit and the upper limit, which define the estimation range for the first time step, a computer arranged to return a control of the system to be controlled for the current time step on the basis of the sum between the error vector of the current time step multiplied by a factor calculated on the basis of the feedback gain matrix, the homogenous canonical norm value range for a current time step, the proportional coefficient, the derivative coefficient and the expansion generator matrix, and a value representing the integral between the first time step and the current time step of a product associating the integral coefficient, the expansion generator matrix, the homogenous canonical norm value range for all the time steps and the error vector.

The applicant has designed a controller of a new type, with improved performance with respect to a linear PID controller. The applicant has implemented this new controller in a system initially controlled with a linear PID controller while taking advantage of the tunings already carried out by a manufacturer on this linear PID controller.

This device is particularly advantageous since it improves the response time and the robustness of the system compared to a linear controller characterised by the coefficients kp, ki and kd. These improvements are very simple to implement, since the system overall is only slightly modified. Finally, compared to a linear PID controller, the additional cost in terms of complexity and calculation load is very low.

According to various embodiments, the invention can have one or more of the following features:
the computer is arranged to calculate the factor calculated on the basis of the feedback gain matrix, the homogenous canonical norm value range for a current time step, the proportional coefficient, the derivative coefficient and the expansion generator matrix according to the formula
$${K}_{0} + {\left‖E \left(t\right)\right‖}_{P} {}^{1 + m} \left(K - {K}_{0}\right) exp \left(- G \text{ln} \left({\left‖E \left(t\right)\right‖}_{P}\right)\right)$$
where K₀ is the feedback gain matrix, m is the homogeneity factor, ||E(t)||_{P} is a value drawn from the homogenous canonical norm value range for the current time step, K is a matrix associating the proportional coefficient and the derivative coefficient, and G is the expansion generator matrix,
the computer is arranged to calculate the value representing the integral between the first time step and the current time step of a product associating the integral coefficient, the expansion generator matrix, the homogenous canonical norm value range of the time steps and the error vector according to the formula
$${\int }_{0}^{t} \left[{K}_{i} 0\right] \text{exp} \left(- G \text{In} {\left(\left‖E \left(τ\right)\right‖\right)}_{P}\right) E \left(τ\right) d τ$$
where Kᵢ is the integral coefficient, G is the expansion generator matrix, and ||E(t)||_{P} is a value drawn from the homogenous canonical norm value range for the time step τ,
the computer is arranged to take, as the value in the homogenous canonical norm value range for a given time step, the upper limit of this range,
the computer is arranged to use the upper limit of the homogenous canonical norm value range for the current time step as the value drawn from the homogenous canonical norm value range for the current time step,
the estimator determines the homogenous canonical norm value range for a current time step by initialising a lower range value and an upper range value with the limits of the homogenous canonical norm value range of the preceding time step and by applying:
   a first test determining whether the product of the transpose of the product of the error vector of the current time step and of the transpose of the exponential of the product of the expansion generator matrix by the negative of the logarithm of the upper range value, of the Lyapunov matrix, and of the product of the error vector of the current time step and of the transpose of the exponential of the product of the expansion generator matrix by the negative of the logarithm of the upper range value is greater than 1, and, if necessary, the definition of the homogenous canonical norm value range of the time step of the current time step between the upper range value and the smaller out of double the upper range value and the upper limit,
   a second test, applied if the first test is negative, determining whether the product of the transpose of the product of the error vector of the current time step and of the transpose of the exponential of the product of the expansion generator matrix by the negative of the logarithm of the lower range value, of the Lyapunov matrix, and of the product of the error vector of the current time step and of the transpose of the exponential of the product of the expansion generator matrix by the negative of the logarithm of the lower range value is greater than 1, and, if necessary, the definition of the homogenous canonical norm value range of the current time step between the larger out of half the lower range value and the lower limit and the lower range value,
   a loop if the second test is negative, which iteratively updates the lower range value and the upper range value by calculating the average between the lower range value or the upper range value, by determining whether the product of the transpose of the product of the error vector of the current time step and of the transpose of the exponential of the product of the expansion generator matrix by the negative of the logarithm of the average between the lower range value or the upper range value, of the Lyapunov matrix, and of the product of the error vector of the current time step and of the transpose of the exponential of the product of the expansion generator matrix by the negative of the logarithm of the average between the lower range value or the upper range value is less than 1, and by updating the upper range value with the average between the lower range value or the upper range value if this is the case, and the lower range value with the average between the lower range value or the upper range value if not.

The invention also relates to a quadrotor that comprises a device according to the invention to calculate a control on the basis of a set point received at the input and a computer program product arranged to implement the estimator and the computer of the device according to the invention.

### BRIEF DESCRIPTION OF THE DRAWINGS

Other features and advantages of the invention will be clearer upon reading the following description, drawn from examples given for illustrative and non-limiting purposes, drawn from the drawings in which:

FIG. 1 shows a diagram of a coordinate system of a quadrotor,

FIG. 2 shows a diagram of a device according to the invention,

FIG. 3 shows an example of an operating loop of the device of FIG. 2,

FIG. 4 shows a specific exemplary embodiment of a function of FIG. 3,

FIG. 5 shows a specific exemplary embodiment of another function of FIG. 3,

FIG. 6 shows a comparison of the precision between a set point, a conventional PID control, and the homogenous PID control of the invention in the dimension x,

FIG. 7 La FIG. 7 shows a comparison of the precision between a set point, a conventional PID control, and the homogenous PID control of the invention in the dimension y,

FIG. 8 shows a comparison of the precision between a set point, a conventional PID control, and the homogenous PID control of the invention in the dimension z,

FIG. 9 shows a comparison of the precision between a set point, a conventional PID control, and the homogenous PID control of the invention in the dimension Ψ,

FIG. 10 shows the robustness of the conventional PID control,

FIG. 11 shows the robustness of the homogenous PID control according to the invention, and

FIG. 12 quantifies the improvements shown in FIGS. 6 to 11 in the L2 norm.

### DETAILED DESCRIPTION OF ILLUSTRATIVE EMBODIMENTS

The drawings and the description below contain, in essence, elements of a certain nature. They can thus not only be used to better explain the present invention, but also contribute to its definition, if necessary.

The present description is likely to involve elements subject to protection by author’s rights and/or copyright. The owner of the rights does not object to the identical reproduction by anyone of the present patent document or of its description, as it appears in the official files. For the rest, they reserve the entirety of their rights.

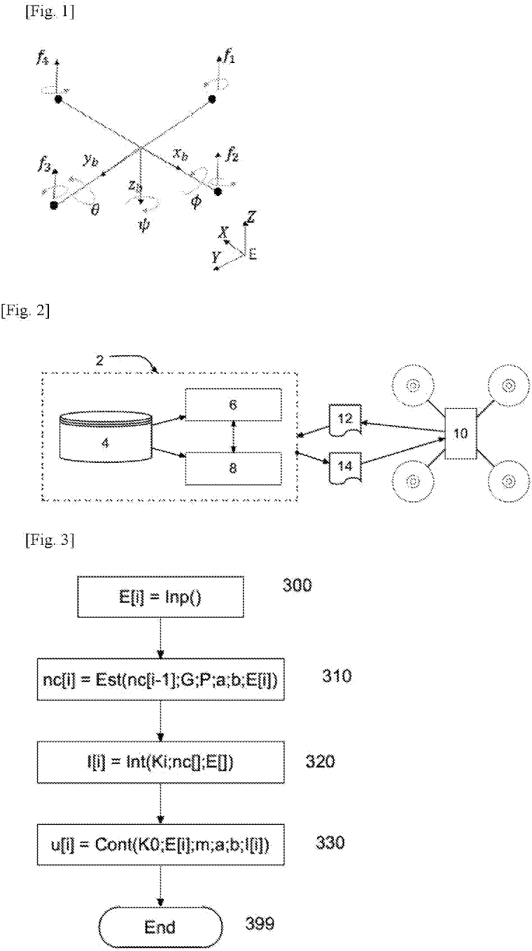

FIG. 1 shows a diagram of a coordinate system of a quadrotor. This system will be used to explain the conventional operation of a system controlled by the device according to the invention.

In this system, 4 rotors exert respective forces f₁ to f₄, for example to make a drone fly. The control of the rotors is carried out via a control u that is a vector of dimension 4.

By writing the list of forces and Newton’s second law of motion, it can be written that the model linearised around in “flight” mode governs the movement of the drone:

$$\left[\begin{matrix}\ddot{x} \\ \ddot{y} \\ \ddot{z}\end{matrix}\right] = \left[\begin{matrix}g θ \\ - g θ \\ \frac{1}{M} {u}_{1}\end{matrix}\right]$$

$$\left[\begin{matrix}{I}_{x x} \ddot{Φ} \\ {I}_{y y} \ddot{θ} \\ {I}_{z z} \ddot{Ψ}\end{matrix}\right] = \left[\begin{matrix}{u}_{2} \\ {u}_{3} \\ {u}_{4}\end{matrix}\right]$$

where g is the gravitational constant, M is the mass, Iₓₓ, I_{yy}, I_{zz} are the moments of inertias with respect to the axis x, y, z, and the uⱼ(j = 1,2,3,4) are the components of the control u = F(f₁, f₂, f₃, f₄) hence F: R⁴ → R⁴ is an invertible mapping, an example of which can be found in the article by Wang, S., Polyakov, A., & Zheng, G. “Quadrotor Control Design under Time and State Constraints: Implicit Lyapunov Function Approach” in 2019 18th European Control Conference (pp. 650-655). IEEE.

By writing the variables

$${A}_{x} = {A}_{y} = \left[\begin{matrix}0 & 1 & 0 & 0 \\ 0 & 0 & g & 0 \\ 0 & 0 & 0 & 1 \\ 0 & 0 & 0 & 0\end{matrix}\right] , {A}_{z} = {A}_{Ψ} = \left[\begin{matrix}0 & 1 \\ 1 & 1\end{matrix}\right] , {B}_{x} = \left[\begin{matrix}0 \\ 0 \\ 0 \\ \frac{1}{{I}_{y y}}\end{matrix}\right] , B y = \left[\begin{matrix}0 \\ 0 \\ 0 \\ \frac{1}{{I}_{x x}}\end{matrix}\right]$$

$${B}_{Ψ} = \left[\begin{matrix}0 \\ \frac{1}{{I}_{z z}}\end{matrix}\right] , {B}_{z} = \left[\begin{matrix}0 \\ \frac{1}{M}\end{matrix}\right] , {C}_{x} = {C}_{y} = \left[1 0 \text{0 0}\right] , {C}_{z} = {C}_{Ψ} = \left[1 \text{0}\right]$$

the equations Math 1 and Math 2 can be reformulated in the form

$$\begin{matrix}\dot{r} = A r + B u , & s = C r\end{matrix}$$

where r(t) represents a state vector in the coordinate system of FIG. 1, u(t) is the control vector, and s(t) represents the real coordinates that it is desired to control by the control u(t), out of the 4 following cases:

$$i f r = \left⌈\begin{matrix}x \\ \dot{x} \\ θ \\ \dot{θ}\end{matrix}\right⌉ , t h e n A = {A}_{x} , B = {B}_{x} , u = {u}_{2} , C = {C}_{x}$$

$$i f r = \left[\begin{matrix}y \\ \dot{y} \\ - Φ \\ - \dot{Φ}\end{matrix}\right] , t h e n A = {A}_{y} , B = {B}_{y} , u = {u}_{3} , C = {C}_{y}$$

$$i f r = \left[\begin{matrix}z \\ \dot{z}\end{matrix}\right] , t h e n A = {A}_{z} , B = {B}_{z} , u = {u}_{1} , C = {C}_{z}$$

$$i f \text{} r = \left[\begin{matrix}Ψ \\ \dot{Ψ}\end{matrix}\right] , t h e n A = {A}_{Ψ} , B = {B}_{Ψ} , u = {u}_{4} , C = {C}_{Ψ}$$

Conventionally, the matrices A, B and C are known for a given system to be controlled, and the control is controlled by a proportional integral derivative control according to the following formula:

$$u = \left[{K}_{p} {K}_{d}\right] \left[\begin{matrix}e \\ \dot{e}\end{matrix}\right] + {\int }_{0}^{t} {K}_{i} e \left(τ\right) d τ$$

where e represents the error, that is to say the difference between the real value of y and the desired value for y, Kₚ is the proportional coefficient of the control, K_{d} is the derivative coefficient of the control, and Kᵢ is the integral coefficient of the control.

It is this type of control that the invention improves, by introducing the notion of homogenous proportional integral derivative control. For this, it uses the parameters already known which are the matrices A, B and C of the model linearised around the operational point of the system to be controlled, as well as the coefficients Kₚ, K_{d} and Kᵢ,.

On this basis, the applicant wrote the following new variables:

$$\begin{matrix}\left\{K = \left[{K}_{p} {K}_{d}\right]\right) , E = \left[\begin{matrix}e \\ \dot{e}\end{matrix}\right] , \text{and D =} \left[\begin{matrix}C \\ C A\end{matrix}\right] i f {K}_{d} \neq 0 \\ K = {K}_{p} E = e , {\text{and D = C if K}}_{d} = 0\end{matrix}$$

On the basis of these new formulas, the applicant sought to use the methods of generalised homogenisation and to adapt them to this problem. They thus first defined a feedback gain matrix K₀ of dimension mᵤ ∗ d which is defined by the following constraint:

$${K}_{0} i s c h o s e n s u c h \text{} t h a t {A}_{0} = D A {D}^{+} + D B {K}_{0} i s a n i l p o t e n t m a t r i x$$

where D⁺ is the pseudo-inverse matrix of the matrix D.

Once the matrix K₀ has been determined, the expansion generator matrix G must be determined. This matrix must be a matrix of dimension d ∗ d which respects the anti-Hurwitz criterion, that is to say that all its eigenvalues have a positive real part, and respects the following constraint:

$$G i s c h o s e n s u c h t h a t {A}_{0} G = \left(G + m I\right) {A}_{0} a n d G D B \text{=} D B$$

where I is the identity matrix, and m is a homogeneity factor comprised in the range [-1; 0].

Finally, once the matrix G has been determined, the Lyapunov matrix P, which will be used to define a homogenous canonical norm, must be determined. The matrix P must be a symmetrical matrix of dimension d ∗ d which respects the following constraints:

$$\left\{\begin{matrix}{\left(D A {D}^{+} + D B K\right)}^{T} P + P \left(D A {D}^{+} + D B K\right) < 0 \\ P G + {G}^{T} P > 0 , P > 0\end{matrix}\right)$$

The work of the applicant has demonstrated that the matrices K₀, G and P exist in the quasitotality of the mechanical systems described above. Thus, these matrices are considered to be parameters intrinsically defined by the system to be controlled and its parameters A, B, C, Kₚ, K_{d}, and Kᵢ.

Once these new parameters have been established, the applicant applied the homogenisation theory, which allowed to define a homogenous control law on the basis of the equation of the formula Math 5 in the following form:

$$u = {K}_{0} E \left(t\right) + {\left‖E \left(t\right)\right‖}_{P} {}^{1 + m} \left(K - {K}_{0}\right) e x p \left(- G l n \left({\left‖E \left(t\right)\right‖}_{P}\right)\right) E \left(t\right)$$

$$+ {\int }_{0}^{t} \left[{K}_{i} 0\right] e x p \left(- G l n \left(\left‖E \left(τ\right)\right‖ \left({}_{P}\right)\right) E \left(τ\right) d τ\right)$$

where exp() is the exponential function, and ||E(t)||_{P} is a homogenous canonical norm defined implicitly by the matrices G and P according to the following constraints:

$$\left\{q i s c h o s e n s u c h t h a t \begin{matrix}{\left‖x\right‖}_{p} = \text{exp} \left(q\right) \\ \sqrt{\left(\text{exp} \left(- G l n \left(q\right)\right) {\left(x\right)}^{T} P \left(\text{exp} \left(- G l n \left(q\right)\right) \left(x\right) = 1\right)\right)}\end{matrix}\right\}$$

The homogenous canonical norm is the object of detailed explanations in the article by Polyakov et al “Sliding mode control design using canonical homogeneous norm” International Journal of Robust and Nonlinear Control, 2019, vol. 29, no 3, p. 682-701.

The advantage of this reformulation is that it allows to define a proportional integral derivative control in which the coefficients Kₚ, K_{d}, and Kᵢ are no longer fixed, but can vary over time, which allows the homogenous proportional integral derivative control to have better performance.

However, the formula Math 10 remains very complex to solve in general, in particular the determination of the value of the homogenous canonical norm according to the formula Math 11. The applicant thus used a digital algorithm to estimate online this homogenous canonical norm.

The device described with FIGS. 2 to 5 does this. FIG. 2 shows a diagram of a device according to the invention.

The device 2 comprises a memory 4, an estimator 6 and a computer 8. The device 2 receives operating data 12 of a system to be controlled 10, and the computer 8 emits to the system 10 a control 14.

The memory 4 can be any type of data storage suitable for receiving digital data: hard disk, hard disk with flash memory, flash memory in any form, RAM, magnetic disk, storage distributed locally or in the cloud, etc. The data calculated by the device can be stored on any type of memory similar to the memory 4, or on the latter. This data can be erased after the device has carried out its tasks or preserved.

In the example described here, the memory 4 receives the parameters described above, namely the homogeneity factor m chosen in the range [-1; 0], the feedback gain matrix K₀, the expansion generator matrix, the Lyapunov matrix defining the homogenous canonical norm, the proportional coefficient Kₚ, the derivative coefficient K_{d} and the integral coefficient Kᵢ characteristic of the system to be controlled.

The memory 4 also receives a lower limit a, an upper limit b, and a number of loops N. Indeed, during their work, the applicant discovered an algorithm allowing to estimate a range of values approaching the value of the canonical norm. This algorithm will be described with FIG. 3. However, in order to guarantee its convergence, it is necessary to threshold a part of the calculations with the lower limit a and the upper limit b, and to define a number of loops N.

The estimator 6 and the computer 8 are elements directly or indirectly accessing the memory 4. They can be produced in the form of a suitable computer code executed on one or more processors. Processors should be understood as any processor adapted to the calculations described above. Such a processor can be produced in any known manner, in the form of a microprocessor for a personal computer, a dedicated chip of the FPGA or SoC type, a calculation resource on a grid or in the cloud, a microcontroller, or any other form capable of providing the calculation power necessary for the embodiment described below. One or more of these elements can also be produced in the form of specialised electronic circuits like an ASIC. A combination of processor and of electronic circuits is also possible.

Although the estimator 6 and the computer 8 are described separately from the system 10 in FIG. 2, they are provided to be integrated into the latter, either by modification of the controller of the system 10, or by addition to the latter. In other words, the goal of the device 2, although shown and described separately, is to be intimately integrated into the system 10 and to replace its linear proportional integral derivative control. It remains possible, however, to produce it in the form of an addition that is grafted onto a system 10 and bypass the control of the latter.

FIG. 3 shows an operating loop of the device 2. As explained above, the device 2 is digital and uses the fact that the systems 10 for which it is designed are also digital. This means that it operates by discrete time steps. Thus, instead of speaking of a time variable t, hereinafter an index i will be used that designates a number of time steps, and thus a time t equivalent to the product of the index i by the duration of the time step of the device 2.

FIG. 3 is thus presented in the form of an updating loop that receives at the input in an operation 300 error vector E data 12 and which emits at the output in an operation 399 control u data 14 to the system 10. Advantageously, all the elements calculated in the various loops are stored in the memory 4. Alternatively, these elements could not be stored, and, when a function refers to a past value, the latter could be recalculated.

In an operation 310, the estimator 6 executes a function Est() in order to determine a value range that approaches the value of the homogenous canonical norm of the formula Math 11.

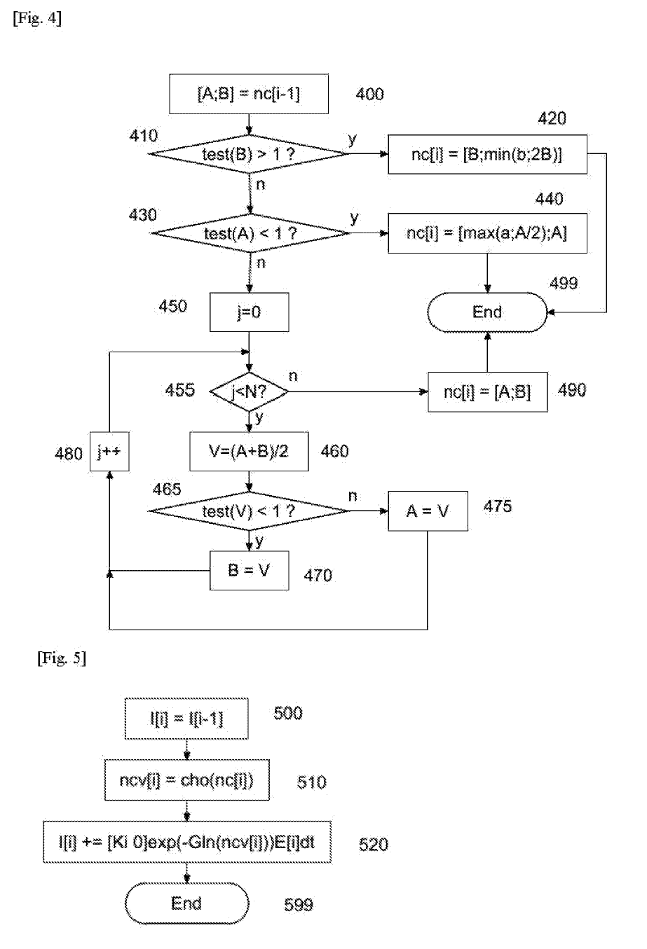

FIG. 4 shows an embodiment as an example of the function Est(). The function Est() is based on the test of a value in order to determine directly or in a dichotomous manner the limits of the range that approaches the value of the homogenous canonical norm.

For the first time step, this range is set by the lower limit a and the upper limit b, that is to say that nc[0] is equal to [a; b]. Then, for each time step, this function starts in an operation 400 by initialising the lower limit value variable A and the upper limit value variable B with the values of the limits of the range determined in the preceding step nc[i-1].

Then, two tests are carried out in order to determine whether a case of direct convergence is available, or whether a loop by dichotomy must be executed.

The first test is carried out in an operation 410 with the execution of a function test() with the upper limit value variable B as an argument. The test function is as follows:

$$t e s t \left(x\right) = \left(\text{exp} \left(- G l n \left(x\right)\right) E {\left[i\right]}^{T} P \left(\text{exp} \left(- G l n \left(x\right)\right) E \left[i\right]\right)\right)$$

If the value of test(B) is greater than 1, then the range nc[i] is determined in an operation 420 as being comprised between the upper limit variable B and the smaller out of double the upper limit variable B and the upper limit b. Then, the function terminates in an operation 499.

If the value of test(B) is less than 1, then the second test is carried out in an operation 430. Here, it is the lower limit value variable A that is given as an argument to the function test().

If the value of test(A) is less than 1, then the range nc[i] is determined in an operation 440 as being comprised between the greater out of half the lower limit variable A and the lower limit b on the one hand and the lower limit variable A on the other hand. Then, the function terminates in the operation 499.

If the value of test(A) is greater than 1, then the range nc[i] is calculated by dichotomy in a loop that starts by the initialisation of a loop index j to 0.

Then, an end of loop condition is tested in an operation 455 by comparing the index j to the number of loops N. If the latter has not been reached, then the loop starts in an operation 460 by the calculation of a dichotomy variable V that is set to half the sum of the lower limit value variable A and the upper limit value variable B .

The dichotomy variable V is then given as an argument to the function test() in an operation 465. If the value of test(V) is greater than 1, then the upper limit value variable B is updated with the dichotomy variable V in an operation 470. If the value of test(V) is greater than 1, then the lower limit value variable A is updated with the dichotomy variable V in an operation 475.

Finally, the index j is incremented in an operation 480 and the loop continues with the test of the operation 455. Once the loop has ended, the range nc[i] is defined in an operation 490 as comprised between the lower limit value variable A and the upper limit value variable B and the function Est() terminates in the operation 499.

It appears that the value of the number of loops N is an important factor and constitutes a compromise to be chosen for the device 2. Indeed, it will regularly happen that the tests of the operations 410 and 430 are negative, in which case the loop is executed, which is more costly in calculation time and in energy consumed. Thus, the value of N should be chosen according to the compromise desired precision / calculation time and energy consumed.

The applicant has discovered that it is possible to use any value of the range nc[i] to approach the value of the homogenous canonical norm of E[i], and that it is advantageous to choose the upper limit of the range nc[i].

Alternatively, the function Est() could be implemented differently, for example by the use of a gradient. In order to guarantee the stability of the control u, it is desirable to threshold the value chosen for the value of the homogenous canonical norm of E[i] between the lower limit a and the upper limit b.

Alternatively, the function Est() can return the value ncv[i] directly instead of the range nc[i].

Once the value of the homogenous canonical norm has been limited, the operation 310 of FIG. 3 is followed by the determination of the value of the integrated term of the formula Math 10, with the execution in an operation 320 of a function Int() by the computer 8.

FIG. 5 shows an exemplary embodiment of the function Int(). In this embodiment, the digital nature of the implementation is utilised by replacing the calculation of the integral term of the formula Math 10 by the addition of the increment to the preceding value.

Thus, the first integral is initialised to 0, and for the following the function starts in an operation 500 by initialising the integral value I[i] of the current step with the integral value of the preceding step I[i-1].

Then, the value of the homogenous canonical norm for the current step is chosen by a function cho() in an operation 510. As described above, in a preferred version, it is the upper limit of the range nc[i] that is chosen.

Finally, in an operation 520, the integral value I[i] is calculated by adding the contribution of the term of the current time step, then the function Int() terminates in an operation 599.

Alternatively, the function Int() could recalculate the value of the integral I[i] by starting over from zero.

Once the value of the integral term has been determined, the control u is calculated in an operation 330 of FIG. 3. For this, the computer 8 executes a function Cont().

The function Cont() carries out the calculation of the following formula:

$$u = {K}_{0} E \left[i\right] + n c v {\left[i\right]}^{\left(1 + m\right)} \left(K - {K}_{0}\right) \text{exp} \left(- G l n \left(n c v \left[i\right]\right)\right) E \left[i\right] + I \left[i\right]$$

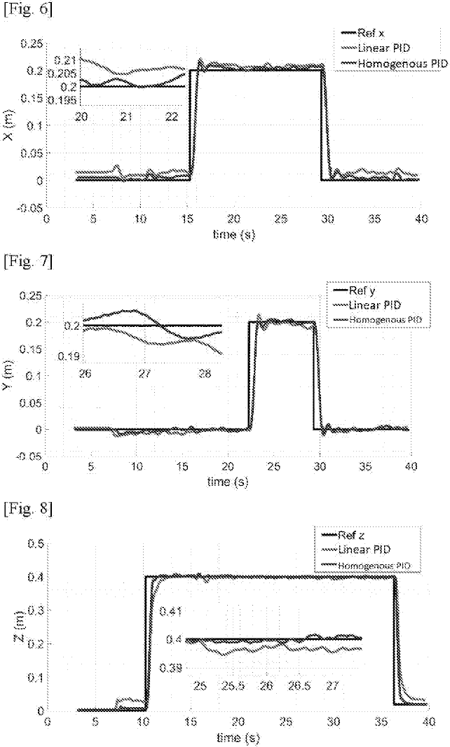

Thus, the resulting control u can be sent to control the system 10. FIGS. 6 to 11 show comparisons between a linear proportional integral derivative control and the homogenous proportional integral derivative control of the device 2.

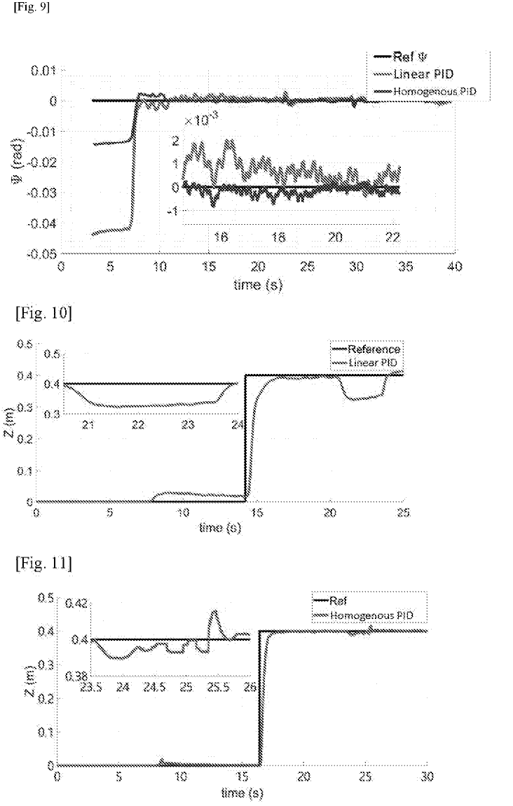

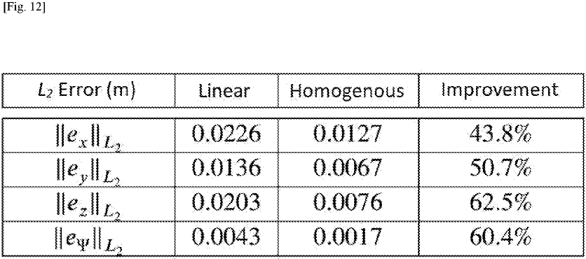

More precisely, FIGS. 6 to 9 show a comparison of the precision between a set point, a conventional PID control, and the homogenous PID control of the invention in the dimensions x, y, z and Ψ each time a close-up view of the stable zone. FIGS. 10 and 11 show the robustness respectively of the conventional PID control and of the homogenous PID control according to the invention. Finally, FIG. 12 quantifies these improvements in the norm L2. As a note, the cost in energy is only 1.1% more with respect to the conventional PID control.

Although the present disclosure has been described with reference to one or more examples, workers skilled in the art will recognize that changes may be made in form and detail without departing from the scope of the disclosure and/or the appended claims.

1. A digital control device for a_control of a system to be controlled digitally, operating by discrete time steps, on the basis of an error vector received by the control device at each time step, the control device comprising:
an input to receive the error vector at each time step;
a memory arranged to receive data of control parameters comprising a homogeneity factor chosen in the range [-1; 0], a feedback gain matrix linked to the system to be controlled, an expansion generator matrix, a Lyapunov matrix defining a homogenous canonical norm, a lower limit, an upper limit, and a proportional coefficient, a derivative coefficient and an integral coefficient characteristic of the system to be controlled;
an estimator arranged to determine a homogenous canonical norm value range for a current time step on the basis of the estimation ranges of the-preceding time steps, the error vector of the current time step, the expansion generator matrix, the Lyapunov matrix, the lower limit and the upper limit, which define the estimation range for the first time step; and
a computer arranged to return a control of the system to be controlled for the current time step on the basis of a sum between the error vector of the current time step multiplied by a factor calculated on the basis of the feedback gain matrix, the homogenous canonical norm value range for a current time step, the proportional coefficient, the derivative coefficient and the expansion generator matrix, and a value representing an integral between the first time step and the current time step of a product associating the integral coefficient, the expansion generator matrix, the homogenous canonical norm value range for all the time steps and the error vector.

2. The digital control device according to claim 1, wherein the computer is arranged to calculate the factor calculated on the basis of the feedback gain matrix, the homogenous canonical norm value range for a current time step, the proportional coefficient, the derivative coefficient and the expansion generator matrix according to the formula
$${K}_{0} + {\left‖E \left(t\right)\right‖}_{P} {}^{1 + m} \left(K - {K}_{0}\right) exp \left(- G ln \left({\left‖E \left(t\right)\right‖}_{P}\right)\right)$$
where K₀ is the feedback gain matrix, m is the homogeneity factor, ∥E(t) ∥ₚ is a value drawn from the homogenous canonical norm value range for the current time step, K is a matrix associating the proportional coefficient and the derivative coefficient, and G is the expansion generator matrix.

3. The digital control device according to claim 1 , wherein the computer is arranged to calculate the value representing the integral between the first time step and the current time step of the product associating the integral coefficient, the expansion generator matrix, the homogenous canonical norm value range of the time steps and the error vector according to the formula
$${\int }_{0}^{t} \left[{K}_{i} \text{0}\right] exp \left(- G ln \left({\left‖E \left(τ\right)\right‖}_{P}\right) E \left(τ\right) d τ\right)$$
where Ki is the integral coefficient, G is the expansion generator matrix, and ∥E(t)∥p is a value drawn from the homogenous canonical norm value range for the time step τ.

4. The digital control device according to claim 2 , wherein the computer is arranged to take, as the value in the homogenous canonical norm value range for a given time step, the upper limit of this range.

5. The digital control device according to claim 4, wherein the computer is arranged to use the upper limit of the homogenous canonical norm value range for the current time step as the value drawn from the homogenous canonical norm value range for the current time step.

6. The digital control device according to claim 1, wherein the estimator is arranged to determine the homogenous canonical norm value range for a current time step by initializing a lower range value and an upper range value with the limits of the homogenous canonical norm value range of the preceding time step and by applying:
a first test determining whether the product of the transpose of the product of the error vector of the current time step and of the transpose of the exponential of the product of the expansion generator matrix by the negative of the logarithm of the upper range value, of the Lyapunov matrix, and of the product of the error vector of the current time step and of the transpose of the exponential of the product of the expansion generator matrix by the negative of the logarithm of the upper range value is greater than 1, and, if necessary, the definition of the homogenous canonical norm value range of the time step of the current time step between the upper range value and the smaller out of double the upper range value and the upper limit,
a second test, applied if the first test is negative, determining whether the product of the transpose of the product of the error vector of the current time step and of the transpose of the exponential of the product of the expansion generator matrix by the negative of the logarithm of the lower range value, of the Lyapunov matrix, and of the product of the error vector of the current time step and of the transpose of the exponential of the product of the expansion generator matrix by the negative of the logarithm of the lower range value is greater than 1, and, if necessary, the definition of the homogenous canonical norm value range of the current time step between the larger out of half the lower range value and the lower limit and the lower range value,
a loop if the second test is negative, which iteratively updates the lower range value and the upper range value by calculating the average between the lower range value or the upper range value, by determining whether the product of the transpose of the product of the error vector of the current time step and of the transpose of the exponential of the product of the expansion generator matrix by the negative of the logarithm of the average between the lower range value or the upper range value, of the Lyapunov matrix, and of the product of the error vector of the current time step and of the transpose of the exponential of the product of the expansion generator matrix by the negative of the logarithm of the average between the lower range value or the upper range value is less than 1, and by updating the upper range value with the average between the lower range value or the upper range value if this is the case, and the lower range value with the average between the lower range value or the upper range value if not.

7. A quadrotorwhich comprises a the device according to claim 1 to calculate athe control on the basis of a set point received at the input.

8. A non-transitory computer readable medium comprising a computer program product, which when executed by a processor of a digital control device, configure the digital control device to implement a method of controlling a system to be controlled digitally, operating by discrete time steps, on the basis of an error vector received by the control device at each time step, the method comprising:
receiving at an input the error vector at each time step;
storing in a memory data of control parameters comprising a homogeneity factor chosen in the range [-1; 0], a feedback gain matrix linked to the system to be controlled, an expansion generator matrix, a Lyapunov matrix defining a homogenous canonical norm, a lower limit, an upper limit, and a proportional coefficient, a derivative coefficient and an integral coefficient characteristic of the system to be controlled;
determining a homogenous canonical norm value range for a current time step on the basis of the estimation ranges of preceding time steps, the error vector of the current time step, the expansion generator matrix, the Lyapunov matrix, the lower limit and the upper limit, which define the estimation range for the first time step; and
returning a control of the system to be controlled for the current time step on the basis of a sum between the error vector of the current time step multiplied by a factor calculated on the basis of the feedback gain matrix, the homogenous canonical norm value range for a current time step, the proportional coefficient, the derivative coefficient and the expansion generator matrix, and a value representing an integral between the first time step and the current time step of a product associating the integral coefficient, the expansion generator matrix, the homogenous canonical norm value range for all the time steps and the error vector.

9. A process implemented by a control device for controlling a system to be controlled digitally, operating by discrete time steps, on the basis of an error vector received by the control device at each time step, the process comprising:
receiving, by the control device, the error vector at each time step;
storing, in a memory, data of control parameters comprising a homogeneity factor chosen in the range [-1; 0], a feedback gain matrix linked to the system to be controlled, an expansion generator matrix, a Lyapunov matrix defining a homogenous canonical norm, a lower limit, an upper limit, and a proportional coefficient, a derivative coefficient and an integral coefficient characteristic of the system to be controlled;
determining, using a processor of the control device, a homogenous canonical norm value range for a current time step on the basis of the estimation ranges of preceding time steps, the error vector of the current time step, the expansion generator matrix, the Lyapunov matrix, the lower limit and the upper limit, which define the estimation range for the first time step; and
generating, using the processor, a control of the system to be controlled for the current time step on the basis of a sum between the error vector of the current time step multiplied by a factor calculated on the basis of the feedback gain matrix, the homogenous canonical norm value range for a current time step, the proportional coefficient, the derivative coefficient and the expansion generator matrix, and a value representing an integral between the first time step and the current time step of a product associating the integral coefficient, the expansion generator matrix, the homogenous canonical norm value range for all the time steps and the error vector.
